(19) United States
(12) Patent Application Publication
(10) Pub. No.: US 2019/0232982 A1
(43) Pub. Date: Aug. 1, 2019

(54) BRAKE PAD ASSEMBLY

(71) Applicant: FLERTEX SINTER, GENNEVILLIERS (FR)

(72) Inventors: Michèle Henrion, PARIS (FR); Eric Guillet-Revol, RUEIL-MALMAISON (FR); Pauline Mas, CLICHY (FR); François Guillard, ARGENTEUIL (FR)

(21) Appl. No.: 16/311,323

(22) PCT Filed: Jun. 19, 2017
(86) PCT No.: PCT/FR2017/051595

§ 371 Date: Dec. 19, 2018

(30) Foreign Application Priority Data
Jun. 24, 2016 (DE) 202016103354.3

(51) Int. Cl. B61H 5/00; F16D 65/092; F16D 69/04

(52) U.S. Cl. CPC B61H 5/00; F16D 2069/0433; F16D 69/0408; F16D 65/092

(57) ABSTRACT

This brake pad assembly (1) for disk brakes, in particular in rail vehicles, comprises a main plate (2), pad modules (3) attached to the plate, which have a friction lining (9) and a backing plate (10), means (16) for attaching a respective pad module (3) to the plate (2), a plurality of bushes (7), each attachment means being arranged in a respective bush (7), which is inserted into orifices (11,6) provided facing each other in the backing plate (10) and in the main plate (2), through an opening (8) in the friction lining (9). According to the invention, the orifice for receiving the bush in the main plate is a blind hole (6), a bore (15) with a smaller diameter than that of the blind hole (6) being provided in the bottom of said blind hole, said bore (15) passing through the main plate (2), a rivet (16) being inserted into said bore inside the bush (7), said rivet linking the main plate (2) and the backing plate (10). The present invention therefore makes it possible to produce a brake pad assembly in which the link between the pad module and the main plate has a structure that is as simple as possible, while being reliable.

The present invention relates to a brake pad assembly for disk brakes, in particular in rail vehicles, of the type comprising a main plate, pad modules attached to the plate, resting respectively on a diaphragm, which pad modules have a friction lining and a backing plate, this friction lining being attached to the backing plate, means for attaching a respective pad module to the plate, a plurality of bushes, each attachment means being arranged in a respective bush, which is inserted into orifices provided facing each other in the backing plate and in the main plate, through an opening orifices provided facing each other.

The brake pad assemblies have a segmented type structure, wherein each pad module is linked in itself to the main plate such that the various pad modules can execute, independently of each other, limited movements when the brake pad assembly is pressed when functioning, against the brake disk. This is necessary, as during the braking operation, the side of the brake disk, against which the brake pad assembly is pressed, is, by nature, substantially hotter than the opposite side of the brake disk. A heat expansion, more significant on one side than the other, is the result of this. A bulging (shielding) of the respective brake disk thus appears during the braking operation. Because of the structure described at the moment of the brake pad assembly, the various pad modules can, thanks to the limited mobility thereof, follow the variation of the surface, linked to the heating up, of the brake disk.

An essential element of a brake pad assembly according to the invention is the type of link or attachment of the various pad modules to the main plate.

It is already known from prior documents, wherein a bash extends at least partially into a bore of the plate, this bush being linked to an attachment means between the support plate and the pad module. First, EP 0 619 439 and DE 10 2015 10 9 033 will be cited.

In particular, a brake pad assembly of the abovementioned type is known from WO 2016/038135, wherein a bush is inserted in the orifices, provided facing each other This bush is inserted from the side, opposite the pad module, of the main plate in said orifices and it rests by a flange-type edge on an annular-shaped reinforcement applied in the main plate, which surrounds the opening. The bush is provided with an inner thread, wherein is screwed, through the opening of the friction, lining, a screw which rests, by the screwhead thereof, in the friction lining opening on the backing plate.

According to a variant, a bolt is inserted in the sleeve through the friction lining opening. This bolt has, at the end thereof inserted in the bush, an annular groove provided with an elastic ring inserted in the latter. This ring is triggered, during the insertion of the bolt, in a corresponding annular groove in the inner side of the bush.

In the two alternatives provided in this document, considerable production means are required, relating to, on the one hand, the bush, and on the other hand, the bolt or the screw.

The bush must protect the linking means, strictly speaking against the shearing forces, appearing during the braking operation.

In the case of the brake pad assembly known from WO 2016/038135, the diaphragms are arranged such that they bear, by the larger periphery thereof, on the backing plate and, by the smaller periphery thereof, in the annular shoulders formed correspondingly in the main plate. Because of this, the manufacturing of the main plate is also expensive.

Consequently, the present invention aims to produce a brake pad assembly of the abovementioned type, wherein the link between the pad module and the main plate has a structure that is as simple as possible, while however being

The present invention achieves this aim by a brake pad assembly of the abovementioned type, characterized in that the orifice for receiving the bush in the main plate is a blind hole, a bore of a smaller diameter than that of the blind hole being provided in the bottom of this blind hole, this bore passing through the main plate, a rivet being inserted into this bore inside the bush, this rivet linking the main plate and the backing plate.

The bush is inserted, under the invention, through the opening of the friction lining, from the opening of the backing plate to into the blind hole in the main plate. The rivet is inserted through the bore linking the blind hole on the outer side of the main plate, the riveting operation, strictly speaking being subsequently carried out.

It will be noted, that the bushes, described in the documents mentioned above, pass fully through the baseplate. Under these conditions, even if a person skilled in the art was to connect these bushes with a rivet, they would not obtain the combination of a blind hole and a bore of a smaller diameter, configured for receiving the rivet.

According to an advantageous embodiment of the invention, it is provided that the bush has, at one of the ends thereof, a flange-type edge, which rests, in the opening of the friction lining, on the backing plate when the bush is inserted in the blind hole of the main plate, the inner diameter surrounded by the flange being greater than the inner diameter of the bush, such that a shoulder which forms the stop for the closing head of the rivet is formed between the flange and the bush, while the head for positioning the rivet is located pressed into the main plate. The rivet head is thus placed in the alignment with the main plate surface, while the closing head being formed during the riveting operation is pressed against the shoulder in the flange zone.

Advantageously, the main plate is attached in the same manner with the rivets at a dovetailed guide element, configured to be inserted into the brake pad assembly support.

In order to prevent an involuntary rotational movement of the respective pad module during the braking operation, it is advantageously provided, remote from the orifice, receiving the bush, in the backing plate, another orifice being used to receive a clamping rod, which is pressed, into an opening, provided facing the backing plate orifice, in the main plate.

Such that producing the main plate can occur without difficulty, it is advantageously provided that the diaphragm rests, by the larger edge thereof on the periphery, on the main plate, and that the smaller edge on the periphery bears on a stop formed in the backing plate, concentrically surrounding the bush opening. The main plate thus has two flat surfaces, while the support elements for the diaphragm are moved in the backing plate inner face.

The link type according to the invention guarantees, in this scope, the mobility required of the pad module, which can be moved with respect to the main plate in a perpendicular direction with respect to the main plate plane (direction Z) and which is configured so that it can be moved by tiling with respect to the plane X-Y.

The movement possibilities are however limited by the height of the bush, as well as the height and the prestressing of the diaphragm.

The present invention is illustrated and explained in more detail below, using the appended figures, wherein:

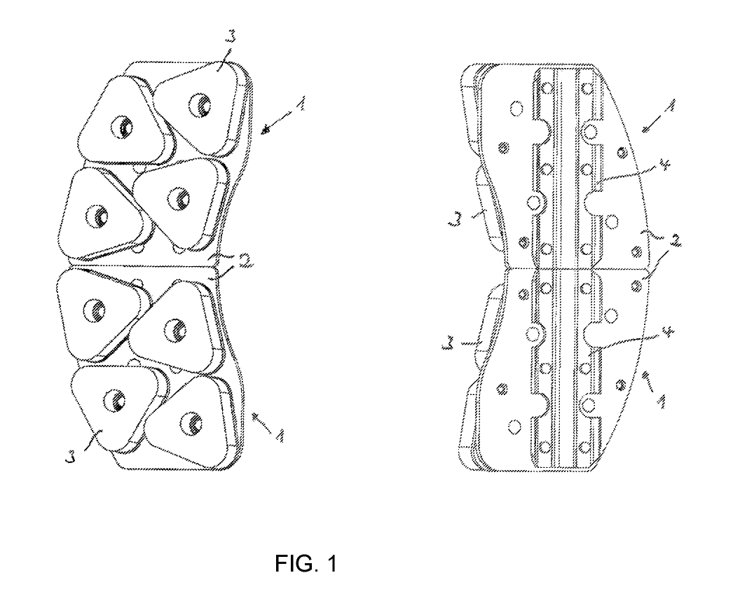

FIG. 1 is a front and rear view of a half of the brake pad assembly composed of two pads;

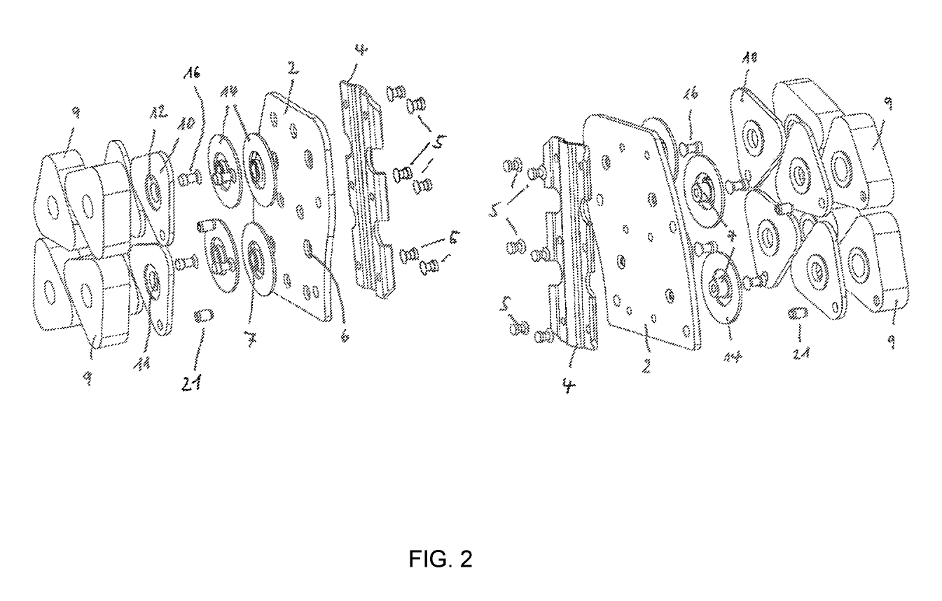

FIG. 2 is an exploded view of the brake pad assembly;

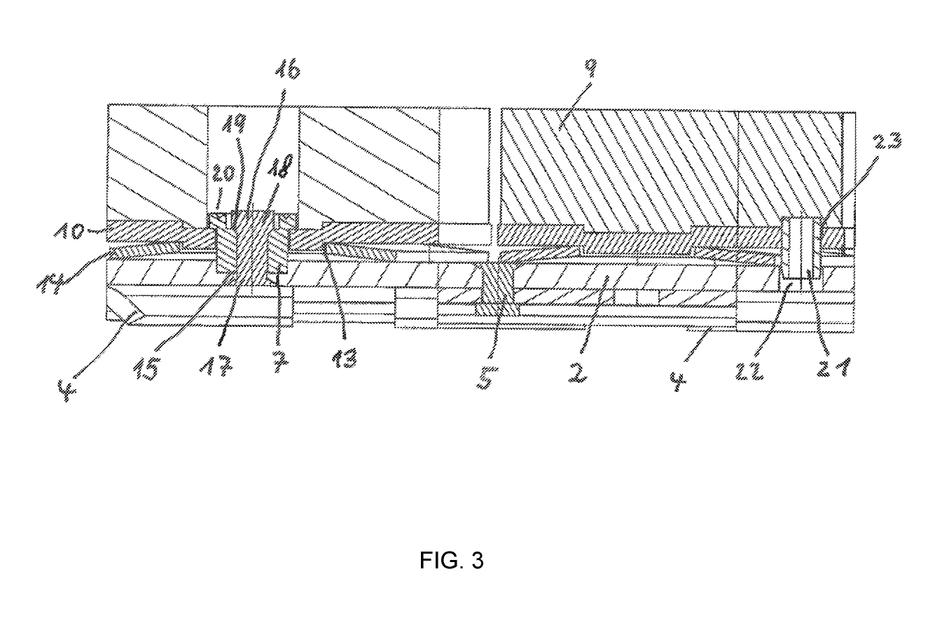

FIG. 3 is a cross-section view of the linking and functional parts of the brake pad assembly;

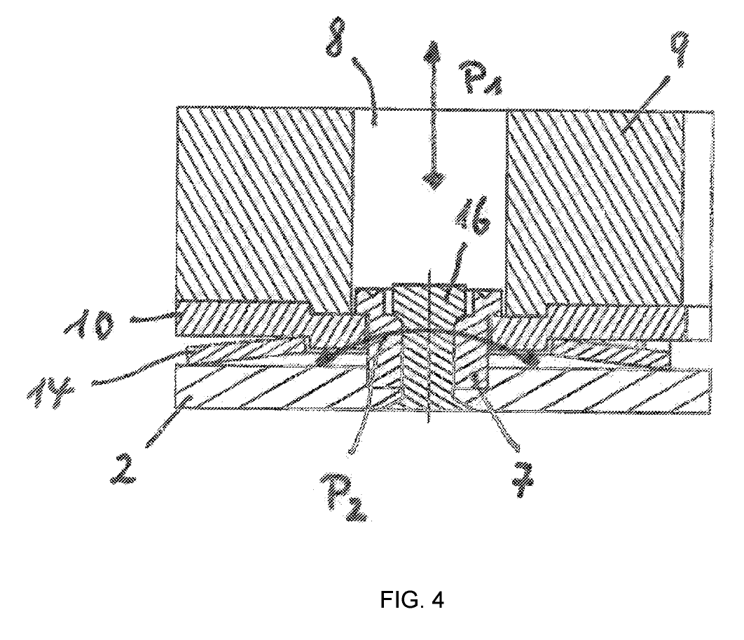

FIG. 4 is a detail of FIG. 3 representing the movement directions of the pad modules.

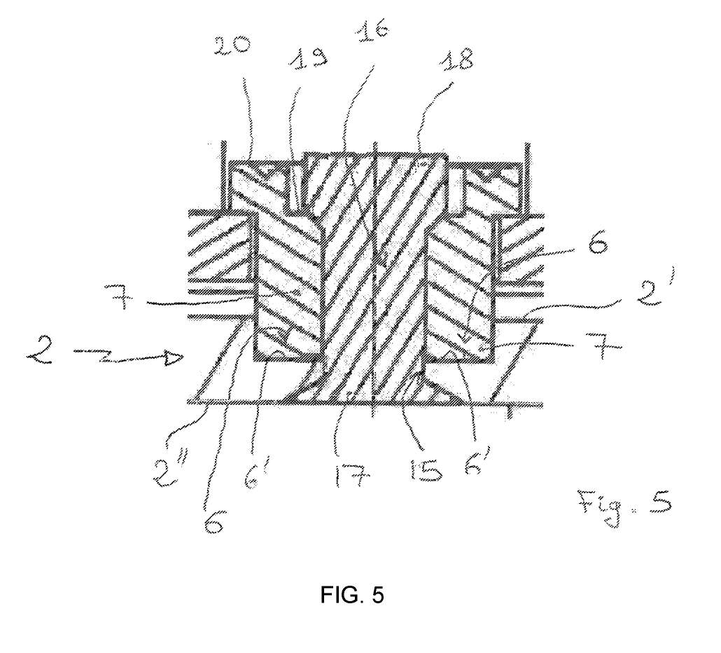

FIG. 5 is a detail of FIG. 3 representing, on a larger scale, the blind hole and the bore provided in the plate of this pad assembly.

FIG. 1 represents a front and rear view of an assembly being used to equip a braking track composed of four individual and symmetrical brake pad assemblies, the respective brake pad assembly being provided with reference number 1. Each brake pad assembly 1 is composed of a main plate 2, on which are arranged, in this case, respectively four pad modules 3. Dovetailed guides 4 are attached on the side of the main plate 2, opposite the pad modules 3.

FIG. 2 illustrates the manner, according to which the individual pad modules 3 are attached to the main plate 2 or are linked to the latter. The dovetailed guides 4 are attached to the rivet means 5 at the main plate. On the side of the main plate 2, opposite the dovetailed guide, the bushes 7 are inserted into the blind holes 6. These bushes 7 are inserted, as well as will appear more clearly in FIG. 3, in the blind hole 6 through an opening 8 in the friction lining 9 of the pad module 3 and through an orifice in the backing plate 10 supporting the friction lining 9. The orifice in the backing plate 10 is assigned, the reference number 11. The orifice 11 surrounds an annular-shaped recess 12, which is formed for example by an operation of pressing the backing plate 10. During said shaping operation, a shoulder 13 is formed at the opposite side of the backing plate 10 with a parallel offset with respect to the annular-shaped recess 12, which shoulder also has an annular shape and surrounds the orifice 11. The annular shoulder 13 acts as support for the smaller edge at the periphery of a diaphragm 14, of which the larger edge at the periphery rests on the main plate 2.

A bore 15 extends from the blind hole 6, provided in the main plate 2, through the main plate 2. As FIG. 5 shows, the blind hole 6 is configured for receiving the bush 7. It leads to the upper face 2′ of the main plate 2, namely to the face of this plate rotated towards the backing plate 10. From the bottom 6′ of this blind hole 6, the abovementioned bore 15 extends towards the bottom in this FIG. 5, so as to lead to the inner face 2″ of the plate, namely to the opposite face thereof to the backing plate 10. The diameter of this bore 15 is smaller than that of the blind hole 6, this bore and this blind hole being concentric, seen from above, in reference to FIG. 5.

A main rivet 16 is plugged by said bore 15 through the bush, up to into the opening 8 of the friction lining, the head for positioning 17 this rivet 16 being located pressed into the main plate 2, such that the surface of said head 17 is placed in the alignment with the surface of the main plate 2.

Through the riveting operation, the closing head 18 of the main rivet 16 is formed, which bears on a shoulder 19, which is arranged in the zone of the bush 7, which reaches into the opening 8 in the friction lining 9. In said zone, the bush 7 has a flange-type edge 20, which rests in the opening 8 on the backing plate 10 when the bush 7 is inserted in the blind hole 6. The inner diameter surrounding the flange-type edge 20 is, in this scope, greater than the inner diameter of the bush 7. The transition zone between the shoulder formed by the flange and the inner wall of the bush 7 is produced, in this scope, with a conical extension.

In order to prevent a torsion of the individual pad modules 3 around said link by riveting to the main rivet 16, a clamping rod 21 is provided, which is threaded, through an orifice 22 in the main plate 2, in a bore 23, provided facing said orifice 22, in the backing plate 10, which is extended in the manner of a blind hole in the friction lining 9, the clamping rod 21 reaching into the orifice 22 of the main plate 2 in the threaded state.

FIG. 4 represents a detail of FIG. 3, the possibility of vertically moving the pad module 3 against the force of the diaphragm 14 being represented by the arrow P1, while the arrow P2 indicates the possibility of moving by tilting in the plane X-Y of the main plate 2.

These movement possibilities guarantee that in the braking mode, the individual pad modules can be adapted to the modified surface of the brake disk.

### LIST OF REFERENCE NUMBERS

1 Brake pad

2 Main plate

2′ Upper face of the main plate 2

2′ Lower face of the main plate 2

3 Pad module

4 Dovetailed guide

5 Rivet

6 Blind hole

6′ Bottom of the blind hole 6

7 Bush

8 Opening

9 Friction lining

10 Backing plate

11 Orifice

12 Annular-shaped recess

13 Annular-shaped shoulder

14 Diaphragm

15 Bore

16 Main rivet

17 Positioning head

18 Closing head

19 Shoulder

20 Flange-type edge

21 Clamping rod

22 Orifice

23 Orifice

1. Brake pad assembly (1) for disk brakes, in particular in rail vehicles, comprising a main plate (2), pad modules (3) attached to the plate, resting respectively on a diaphragm (14), which pad modules nave a friction lining (9) and a backing plate (10), this friction lining being attached to the backing plate (10), means (16) for attaching a respective pad module (3) to the plate (2), a plurality of bushes (7), each attachment means being provided in a respective bush (7), which is inserted in the orifices (11, 6) provided facing each other in the backing plate (10) and in the main plate (2), through an opening (8) of the friction lining (9), which has a greater diameter than the orifices (6, 11) provided facing each other, characterized in that the orifice for receiving the bush in the main plate is a blind hole (6), a bore (15) of a diameter smaller than that of the blind hole (6) being provided in the bottom of this blind hole, this bore (15) passing through the main plate (2), a rivet (16) being inserted into this bore inside the bush (7), this rivet linking the main plate (2) and the backing plate (10).

2. Brake pad assembly according to claim 1, characterized in that the bush (7) has, at one of the ends thereof, a flange-type edge (20), which rests, in the opening (8) of the friction lining (9), on the backing plate when the bush (7) is inserted into the blind hole (6) in the main plate (2), wherein the diameter surrounded by the flange (20) is greater than the inner diameter of the bush (7) such that is formed, between the flange (20) and the bush (7), a shoulder (19), which forms the stop for the closing head (18) of the rivet (16), while the head for positioning (17) the rivet (16) is located pressed into the main plate (2).

3. Brake pad assembly according to claim 1 or 2, characterized in that the main plate (2) is attached, at the opposite side of the friction lining (9), by means of at least one rivet (5), at a dovetailed guide element (4), configured to be inserted into the support of the brake pad assembly.

4. Brake pad assembly according to any one of claims 1 to 3, characterized in that is provided, remote from the orifice (11) receiving the bush (7), in the backing plate (10), another orifice (23) being used to receive a clamping rod (21), which is pressed into an orifice (22), provided facing the backing plate orifice (23), in the main plate (2).

5. Brake pad assembly according to any one of claims 1 to 4, characterized in that the diaphragm (14) rests, by the larger edge thereof on the periphery, on the main plate (2), and in that the smaller edge on the periphery bears on an annular-shaped shoulder (13) formed in the backing plate (10), concentrically surrounding the bush opening and is guided from said shoulder radially.

6. Brake pad assembly according to any one of claims 1 to 5, characterized in that each pad module (3) can be moved with respect to the main plate (2) in a perpendicular direction with respect to the main plate plane (direction Z) and is configured so that it can be moved by tilting with respect to the plane X-Y.
